(19) United States
(12) Patent Application Publication
(10) Pub. No.: US 2012/0271696 A1
(43) Pub. Date: Oct. 25, 2012

(54) Personalized Coupon Delivery System, Web Interface and Method of Use

(76) Inventors: Patricia Akbar, Savannah, GA (US); Rasheed Akbar, Savannah, GA (US)

(21) Appl. No.: 13/452,984

(22) Filed: Apr. 23, 2012

Related U.S. Application Data
(60) Provisional application No. 61/478,268, filed on Apr. 22, 2011.

(51) Int. Cl. G06Q 30/02

(52) U.S. Cl. 705/14.23

(57) ABSTRACT

Disclosed is an electronic coupon delivery and redemption system that utilizes an online interface to bring customers targeted coupons related to the user's demographics, location and interests, and allow the customer to choose a set of coupons for which to load onto their profile. The profile is accessed at the merchant location utilizing a user-specific, magnetic strip card that contains the user's information and pings the online database storing the customer coupons. The coupons are then redeemed and the transaction is adjusted based on the savings from the utilized coupons. Vendors upload coupons and incentives to the online database, which enables targeted messages and incentives to be sent to users. The user chooses a set of coupons to load onto the card for use at a specific merchant location. Consumer trends and targeted sales for venders are facilitated through a completely online and paperless process.

### CROSS REFERENCE TO RELATED APPLICATION

This application claims the benefit of U.S. Provisional Application No. 61/478,268 filed on Apr. 22, 2011, entitled “Eco Coupon Card.”

### BACKGROUND OF THE INVENTION

1. Field of the Invention

The present invention relates to paperless coupon systems and electronic means for redeeming coupons. The present invention further relates to an online interface that provides customers with a tailored set of coupons from which to choose from, wherein the interface is preferably a website server that provides deals and incentives that are particularly suited for a user's demographics, location and spending habits. The coupons are chosen through the web interface and redeemed utilizing a coupon card having a magnetic strip, wherein the merchant runs the card to allow for verification of the user and redemption of the user's chosen coupons.

2. Description of the Prior Art

Recent changes in food industry and marketing practices relating to discounts and distribution of coupons have involved the move from the distribution of redeemable paper coupons to electronic distribution of coupons and incentives. Historically, paper coupons were printed by individual retailers and delivered by hand to the consumer, who then perused the coupon listing and painstakingly cut each desired coupon from the mailing. This involved tremendous output from the retailer, in the form of outgoing expenses for the printing, distribution and collection of such coupons, as well as considerable planning on the part of the retailer, as the time lag between the coupons being printed and the actual sale date may be considerable from conception to redemption. Thousands of dollars were spent in the effort to draw more consumers into the retailer's establishment in order to redeem the coupons, and to further purchase other products which would make up any profit lost in the transaction of the coupon per customer.

Consumers find the traditional practice of cutting coupons to be tedious and outdated, as electronic delivery and formats allow for such incentives to be delivered directly to the consumer. The further act of collecting these coupons and remembering to bring them to the retailer is another activity that the consumer has to track, as the collected coupons must be physically delivered to the merchant checkout location, adding aggravation if the coupons are forgotten on the trip or if any have gone missing. In this event, the consumer would have to locate a circular within the store, clip the coupon and return to the register. This process is tedious, and generally leads the consumer to avoid using coupons or at least forgoing their use if lost during a specific outing.

Yet another objection to traditional coupons are that they are sent in a blanket format, wherein a particular merchant is sending coupons to those individuals who may not necessarily be interested or be appropriate for the seller's merchandise or category of merchandise. The merchant produces such coupons in bulk and distributes them across all households in a given area, independent of the intended recipient. This bulk mail, or junk mail, can quickly aggravate particular consumers who are uninterested in a product or category of products, and further is a waste of materials and resources when considering the volume of such bulk mailings.

The present invention is provided to disclose a new method of coupon distribution and redemption, wherein a first computer database houses a plurality of electronic coupons that are chosen by vendors and delivered directly to consumers, by way of electronic mailings and by the user interacting with the database through a website graphical user interface (GUI). The website interface allows a user to create a profile and choose particular merchant's coupons, while the statistics and demographics of the user are monitored to allow directed marketing thereto and for directly electronic mailings from vendors and for products that may interest the particular user. The coupons are chosen and loaded into an electronic bin, from which a physical magnetic strip card is used to access the user's bin of coupons at the vender checkout location. The vender swipes the card during purchase to redeem the coupon and deduct the purchase price accordingly. The present system, its deployment and its goals are an advancement in the art of coupon distribution and redemption that is useful for both consumers and venders alike, reducing bulk mailing costs and targeting incentives for consumers, and further reducing the tedious nature of traditional coupon clipping. The ability to electronically validate a coupon further reduces fraud on the part of the consumer, who may be utilizing out of date or invalid coupons to redeem sales that are not otherwise available without deliberate or unwitting intent.

There exist methods and systems in the art that relate to coupons and redemption thereof. These devices employ familiar design elements for the purposes of increasing exposure to coupons and improving their deployment for the consumer and vender. However, these devices fail to contemplate the web interface of the present invention and its plurality of uses for both venders and consumers. The following is a listing of what is considered the most relevant prior art devices that have been disclosed in published patent applications or patented.

Specifically, U.S. Pat. No. 6,691,915 to Thaxton is one such device that describes an electronic coupon system and method of processing the coupons using a coupon card for redemption at a point-of-sale terminal utilizing an in-store kiosk as a go-between. The in-store kiosk includes a user interface and a coupon card interface to allow coupon selection and coupon card writing instrumentation operative to write coupon data to the coupon card after user selection of coupons. The card can then be utilized at the point-of-sale, wherein the coupons are read from the card to reduce the price of particular products accordingly. The Thaxton device provides a useful means of allowing consumers to electronically choose in-store coupons at a place of business through the use of an in-store kiosk. However, Thaxton fails to contemplate an in-home computer interface in which coupons can be selected for a variety of stores on a single coupon card, which can then be taken to a specific store to reduce the sale price of particular items for which the coupons are valid therefor. In this way, the present invention provides a new and novel means of delivering coupons and sales from local businesses directly to a consumer, and allowing that consumer to store multiple coupons from multiple businesses on a single card, and without the need to print a plurality of paper coupons.

U.S. Pat. No. 6,014,634 to Scroggie is another device that discloses a system and method for delivering purchasing incentives and retail aids to a consumer over a network, such as the internet or email, wherein the consumer may browse an array of incentives or offers and select particular items for a particular store. The incentives or offers may be redeemed in several ways, including in person at the retail location by way of providing identifying information thereto upon purchase, or a printable graphical image of the incentive may be sent to the consumer for use at the retail location. The Scroggie device offers rebates and coupons in which the consumer may browse from a list and choose which ones are most appealing thereto, whereafter the medium for utilizing the offer includes a printable receipt or token that is redeemed at the retail location. The present invention provides an uploadable card upon which information is stored related to the consumer and his or her chosen coupons, which the consumer may browse from at his or her leisure from a home personal computer and redeem utilizing the card upon checkout.

Further, U.S. Pat. No. 6,041,309 to Laor discloses a method and system for distributing and redeeming electronic coupons, wherein the coupons or tokens are redeemed in a computer network environment. The system includes a communication channel coupled to at least two terminals, one being a client and the other a server. The server responds to user inquiries and also tags coupons or pointers to coupons for the user. The preferred embodiment of the Laor invention includes a personal computer that connects to a web server that transfers a book of coupons to the user's computer via a Cookie, which can then be recognized by other websites and point-of-sale internet locations. The Laor device is primarily a business method concerned with online transactions and communication between computing systems for the purposes of transferring coupons via electronic format, wherein the coupons can be redeemed electronically during a website transaction. The present invention pertains to a loadable coupon credit card that is able to store various coupons related to the user and local businesses, wherein the coupons are redeemable at the purchase location via the merchant's system. The card is swiped, whereafter information regarding the user and the card contents are accessed, verified against a coupon server and utilized to reduce the sale price of a particular item for which the coupon was chosen.

U.S. Pat. No. 5,380,991 to Valencia discloses a system for providing discounts to products purchased at a retail establishment that employs a list of product discounts on a computer system, a checkout station and a card having an interface device and memory. The system employs a smart card having an integrated circuit with erasable memory therein, the memory containing information related to the discount coupon for the particular product, as well as information related to recent purchases. A card reader/writer terminal would read the information from the card memory for redeeming coupons and also write to its memory the purchases in the particular transaction. This allows a shopper to receive the benefit of reduced prices without redeeming paper coupons. While the this invention and method are very closely related to the present invention, the present invention utilizes a card that contains only the user's information, wherein the reader pings a network database to retrieve coupons for products at a point-of-sale location. The card is not limited to a set size of memory, and is less prone to failure as there is not delicate hardware therein. The card contains a readable magnetic strip for a particular system reader to read, ping a server and access the user's information and related coupons.

Finally, U.S. Pat. No. RE. 34,915 to Nichtberger discloses a paperless system for distributing and redeeming coupons at a store location that comprises a display for allowing a customer to select coupons while in the store, recording the selection and aligning the data with a card supplied to the customer. An identification and checkout at the store identifies the purchases and the user, whereafter the coupons are items purchased are matched for crediting the customer by the coupon value. Further disclosed are a central processing unit and a data entry system, along with a locally supplied coupon distribution and redemption unit at the store location for redeeming coupons on a card utilized by the user. The Nichtberger device deploys a redemption interface at the store location for which the customer to utilize for choosing and redeeming in-store coupons. The present invention relates to an independently supported system that the user can connect to via the internet while at home or utilizing a handheld smartphone device, wherein coupons are displayed for the choosing and are also forwarded to the user for particular offers suited to that customer. The customer electronically chooses the coupons via the web interface, updating his or her account, which is tied to a card having a magnetic strip. The card is read at the merchant checkout for redemption of the coupon amount if the particular article is purchased, reducing the overall bill for the user.

The present invention relates to an online system of coupon distribution, sharing and marketing utilizing an interactive website and a coupon card that allows consumers to collect coupons and redeem at vendor point-of-sale locations. The goal is to offer an improved means of coupon distribution that eliminates mass mailings and physical coupons, and opens the door to more directed marketing using details user statistics and buying habits, whereby both consumer and vendor are afforded more efficient means of offering and redeeming coupons. The system and method of use substantially diverges in design elements from the prior art, and consequently it is clear that there is a need in the art for an improvement to existing coupon distribution and delivery methods. In this regard the instant invention substantially fulfills these needs.

### SUMMARY OF THE INVENTION

In view of the foregoing disadvantages inherent in the known types of coupon distributing and redemption methods now present in the prior art, the present invention provides a new system and method wherein the same can be utilized for providing convenience for the user when allowing consumers access to electronic coupons, a community to browse relevant or desired coupons, and for vendors to more directly distribute incentives and coupons to consumers, track consumer behavior and market their products in an online environment.

It is therefore an object of the present invention to provide a new and improved coupon distributing and redemption method that has all of the advantages of the prior art and none of the disadvantages.

It is another object of the present invention to provide an electronic coupon system that reduces physical coupon clipping, distribution and redemption and replaces the traditional methods of coupon distribution and redemption using an online system and a user-specific card that is tied to a user account on the system, whereby the card is utilized to redeem the coupons and the online system is used to distribute and collect the coupons electronically.

Another object of the present invention is to provide an online interface to a network database that links to a user card for storing chosen coupons and for redeeming them at a merchant checkout location, wherein the card is utilized to access the consumer information and the network database for verifying the coupon authenticity before altering the purchase price accordingly.

Yet another object of the present invention is to provide an online coupon network that operates a website user and vendor interface, which provides benefits for both the consumer and vendor, respectively. On the user side, a user can browse coupons, join mailing lists and explore local businesses, while on the vendor side, user statistics can be tracked, bulk or direct electronic mailings or coupon offers are possible, online advertisement is offered and direct competition with competitors is allowed through a virtual, electronic environment.

A final object of the present invention is to create a coupon community where a user and vendor may join for the privileges in which the system offers, while browsing guests may also access the system and download and print direct coupons if desired.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a diagram view of the overall process, whereby the system is accessed by both venders and users via a network, while a physical coupon card is used at the vendor point-of-sale location.

FIG. 2 shows a diagram view of the coupon online database and its available uses for both users and vendors.

FIG. 3 shows a diagram view of both user and vendor activities on the online system.

FIG. 4 shows the site access options for users, vendors and guest users to the website.

FIG. 5 shows a pictorial view of a user engaging the online system via a personal computer interface and choosing coupons to load onto her readable coupon card.

### DETAILED DESCRIPTION OF THE INVENTION

Reference is made herein to the attached drawings. Like reference numerals are used throughout the drawings to depict like or similar elements of the coupon distributing and redemption system and method. For the purposes of presenting a brief and clear description of the present invention, the preferred embodiment will be discussed as used for distributing and redeeming coupons electronically and via a physical, user-specific coupon card. The figures are intended for representative purposes only and should not be considered to be limiting in any respect.

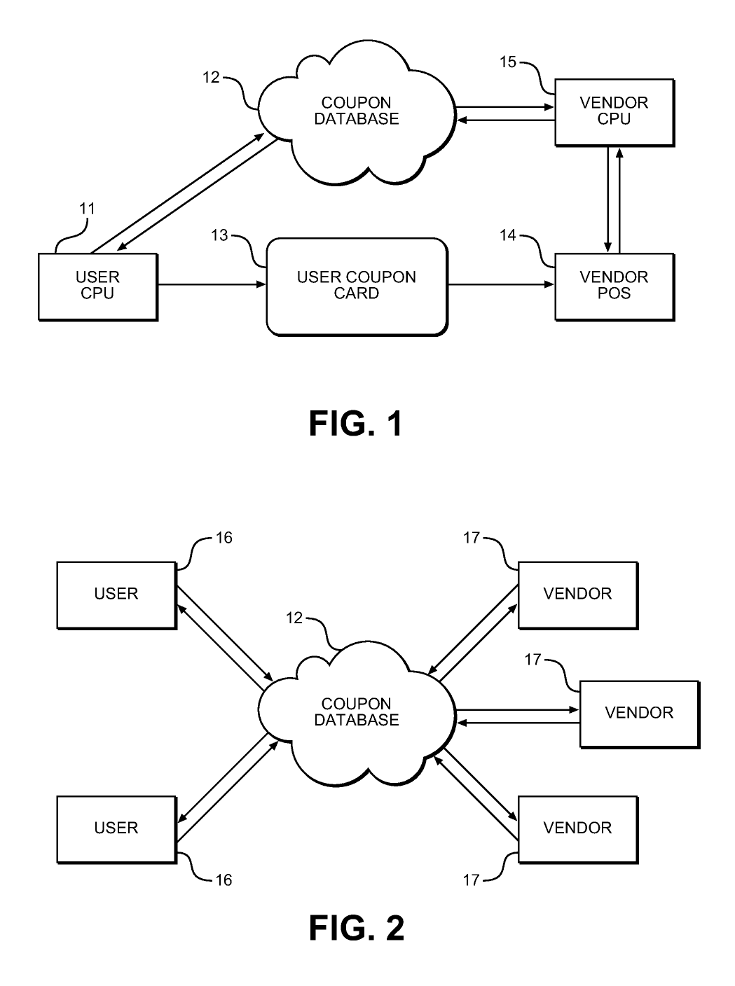

Referring now to FIG. 1, there is shown a schematic view of the overall system from a high level, wherein a coupon database 12 exists on a server or similar computing system, which contains information related to member users and member vendors to provide a coupon exchange and sales tool for both users and vendors alike. The database 12 is accessed preferably through a website interface using a computer processing unit (CPU), from either the user side 11 or the vendor side 15. On the user side 11, the user is able to both extract and send data through the web interface and via email to the coupon database 11 system, including the ability to set up a personal profile that describes the user's demographics and geographic location for targeted coupon direction. The user is able to search for store coupons, join groups that receive particular incentives and further exchange coupons between other users. The user is allotted a number of coupons from which to choose from or is able to download to their profile. This allotted number may be a changing scale based on patronage and use of the system, whereby more extensive users are given more access to coupons. Alternatively, the coupon limit may be set for all users.

Once a coupon or set of coupons is chosen from the database, they are loaded onto a user-specific coupon card 13. The coupon card 13 is physical card preferably having a magnetic strip for accessing the cards information at a vendor point of service (POS) 14 or checkout location. The card 13 is sent to each user for the user to utilize and redeem the coupons from the vendor of choice. When the card is utilized at the vender location 14, it is swiped through a card reader that accesses the coupon database 12 to verify the user and the coupons on the user's card 13. The coupons are validated and the bill of sale is adjusted automatically and accordingly, based on the specific coupon and the deal in which it includes.

Referring now to FIG. 2, there is shown another schematic view of the present invention showing the interaction of both users 16 and vendors 17 with regard to the coupon database 12. The coupon database 12 is a network listing of coupons, user information and vendor information that is stored on a server and accessed using a website graphical user interface and monitored by database and website administrators. The database and website access allows remote viewing of coupons from a personal computer, allows uploading and downloading of coupons and a plurality of functions that facilitate a community of user and vendors, whereby both sides are given various features for both saving money and reaching new customers.

On the user side 16, the users can create personal profiles that allow local businesses and those businesses which suit their interests, demographics and other personal traits to be directed thereto. This opens up the user's experience to include local businesses and businesses that he or she may not otherwise be aware of, providing coupons and other incentives for sending their business to those businesses. Users can also browse the catalog of coupons, using a search tool that enables searching by various categories, including type of service, location, a listing of best deals, and so on. Users can also interact with both the vendors and other users in the broad community, joining mailing lists, sending direct messages to other users and vendors, and also swapping coupons between other users.

On the vendor side 17, there are a similar number of features that facilitate a community of interconnected vendors and a means to improve business sales for all of those involved. The vendors 17 are able to communicate with the coupon database 12 for uploading coupons, deals and other incentives which are targeted at the user side 16 of the system. These coupons can be directed to a specific demographic user, specific geographic location or target users who are a specifically interested in a product or vendor type. Users can ‘follow’ certain vendors are receive direct notice when a sale initiates or be privy to particular coupon deals for only those in the follower group. Vendors also have access to user statistics across the database, enabling the vendors to chart trends or target their marketing through the website and in their outside business. Vendors can then activate sales and coupons for which the users are able to choose from.

The physical transfer of goods and the redemption of coupons occurs at the vendor's place of business or on their particular website, if website sales are included on the coupon. In the in-store transaction, a user-specific coupon card is swiped during checkout, which pings the coupon database for the user's information and his or her loaded coupons. If the vendor and the particular item are cross-referenced on the database and the registered items are being purchased, the user's coupon is redeemed and the purchase price is adjusted accordingly. The coupon on the database can be utilized for multiple purchases or may alternatively be valid for only a single use, depending on the coupon type. If valid for a single use, the coupon is removed from the user's profile after it is redeemed at the store, whereby the coupon database registers that the user has redeemed that coupon at the vendor location and removes it from the user's list of coupons. Thereafter the user may then be barred from acquiring that same coupon, if there is a limit of one coupon per person. If the coupon is valid for multiple uses, the coupon may stay active on the user's account until it expires or is removed from by the user on the database. The use of a physical card that is read at the vendor location validates the coupon and user authenticity, and reduces instances of coupon fraud or forgery on the part of the user, whereby excessive or invalid coupons are utilized in a transaction.

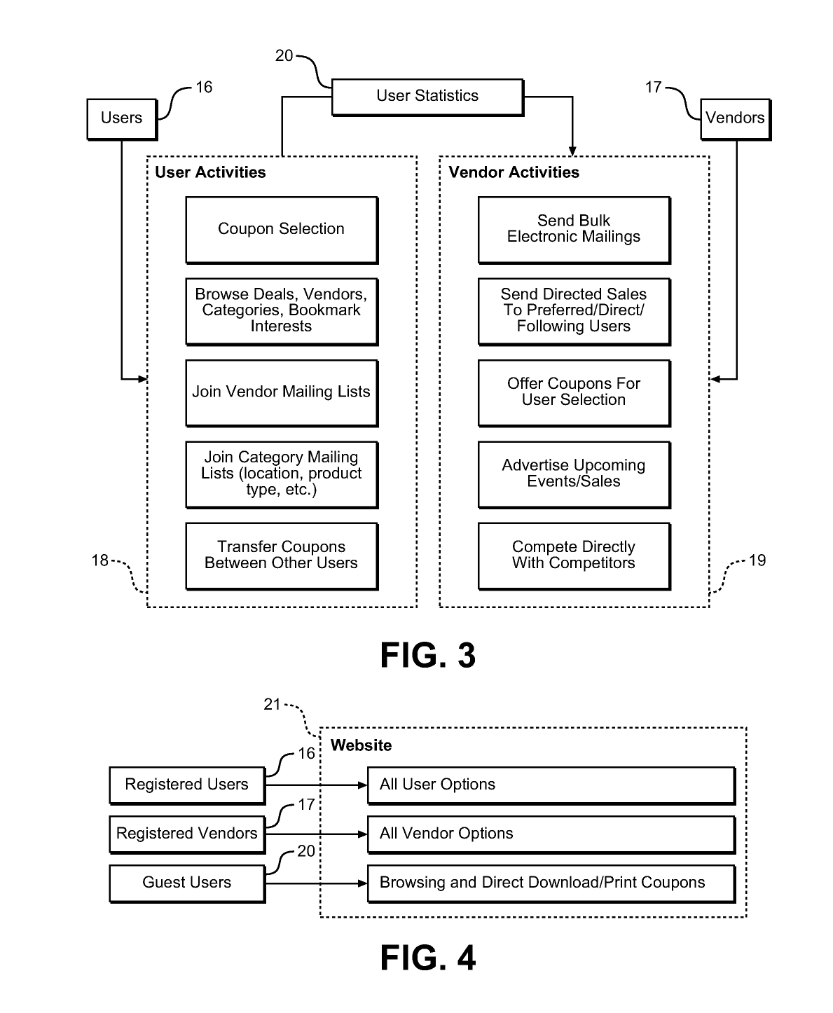

Referring to FIG. 3, there is shown schematic view of the coupon database features, broken down into the user activities and the vendor activities, and how the two are related through user statistics for the purposes of allowing vendors to tailor their marketing and incentive strategies accordingly. Users 16 access the coupon database site and are provided a plurality of functions 18 for the purposes of browsing vendors, searching for deals and activating coupons to their respective coupon cards. Specifically, the user side is meant to be a visual listing of vendors and recent incentives, while also being a search tool for local or user-interested vendors. Users can follow specific vendors and be included in exclusive deals, whereby they join mailing lists for specific vendors. They can also join broad category mailing lists for coupon listings of broader categories, such as athletic equipment, car accessories, etc. Finally, the community of users may swap and transfer exclusive coupons between one another, allowing users the opportunity to obtain a coupon that they may have missed the opportunity to secure or gain access to more exclusive coupon deals.

For vendors 17, the present coupon system provides a means to smartly form a marketing strategy and delivery coupons to customers in a more efficient process, without the need to create mass mailings of physical coupons to be hand-clipped. Vendors have access to market and user statistics 20 from the community of users, allowing them to tailor their marketing campaigns and coupon strategies for the current market climate and specific user trends. Vendors are much like users on the system, however they create the coupons and deals, while the users 16 are the ones choosing and redeeming the coupons on the opposing side via the user-specific card. On the vendor side 19, vendors can send bulk electronic coupon mailings to a group or targeted list of users, or alternatively send specific or exclusive coupons to preferred or following users. The vendors can each have their own specific coupon website location, where the store details and its incentives can be listed for the user to browse both the vendor and its coupons thereon. Vendors can advertise through this network and have their advertisements placed on global banners on the website for broad marketing to new and existing customers. The vendors can also compete with other vendors by seeing customer coupon deals offered by their direct competitors.

Referring now to FIG. 4, there is shown a view of the rights and abilities of the different categories of users of the system and its interface to the coupon database. The three main categories of users of the website are registered users 16, vendors 17 and guest users 20. The first two are registered with the website 21 and system, and are granted all access to viewing, uploading/downloading coupons and interacting with the system and its users. Guest users 20 are a third type of user for that person or vendor who is just learning of the system and website, and would like to peruse its functionality. These are generally new users that do not wish to be registered yet, and are given reduced functionality with regard to access to the site 21. These users are limited to browsing the vendor list and their listing of coupons, but are restricted to only downloading printable coupons, as these members do not have a membership coupon card that comes with user registration. Therefore they are not able to redeem their coupons electronically and must download physical copies. Printable coupons are a means to entice a user to use the site and download a small fraction of available coupons to test the system. Most coupons are only redeemable using the coupon card, therefore registration is encouraged and more users join the system and in turn make more vendors join the network.

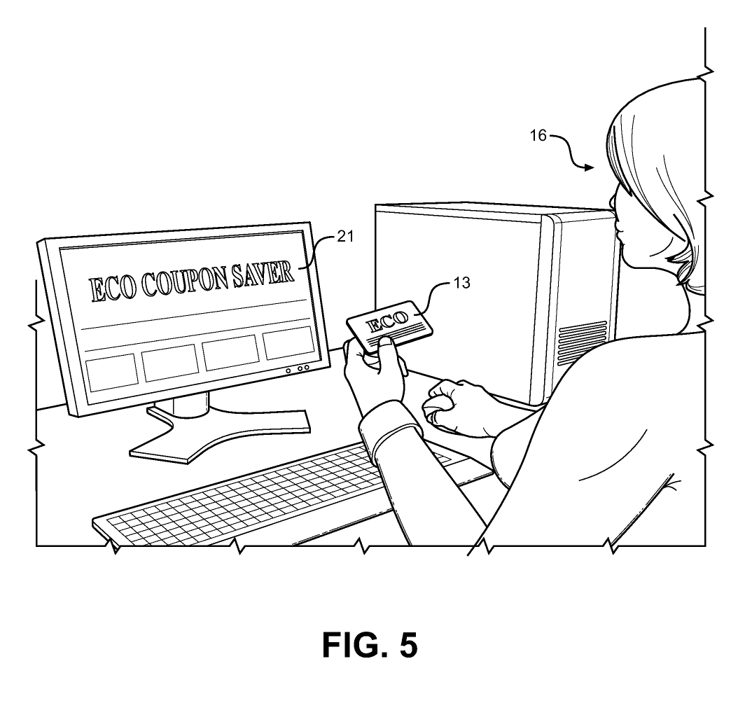

Referring now to FIG. 5, there is shown a pictorial view of a user 16 interacting with the present system online interface 21 and uploading coupons onto her specific coupon card 13. No physical connection of the card 13 is required when choosing coupons from the system, as the card is merely a magnetic-strip card readable by a card reader that has access to the system database and can find the customer information (and coupons) via the connection. No readable media or memory is included on the coupon card, reducing its complexity to merely a registration card that tells the card reader to find the user's information during checkout. Coupons can be downloaded to the user's profile and stored until use purely electronically. This allows the user to choose coupons while at home, or alternatively while at the vendor store location via a smartphone application that provides similar online functionality.

Overall, the present coupon system and distribution method are equally beneficial for both vendors and users. Users are given a large community of vendors and other users to browse and exchange coupons, while vendors are given a means to directly market and distribute coupons to a community of users. Vendors can choose a specific target user or group of users for which to send coupons or incentives, using vital spending, browsing and user characteristics charted by the system for use by the vendors in their marketing and incentive programs. The system utilizes an online network and database of coupons/users/vendors, and deploys the system using a user-specific, readable card that the customer carries and the vendors are able to read using an appropriate magnetic card reader connected to the online network for pinging the user information and adjusting a given transaction, all in real time during checkout procedures.

It is not desired to completely eliminate traditional means of coupon distribution and marketing, but rather it is desired to disclose a new and novel means of distributing such coupons and improving directed marketing to a community of users. It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A coupon distribution system, comprising:
a computer system having a database listing of registered users, vendors, coupons from said vendors, mailing distribution lists and user information, spending and browsing statistics;
an online interactive interface to said computer system;
said interface allowing users to register on said system, browse vendors and vendor coupons, interact with other users and join mailing distribution lists;
said interface allowing vendors to register on said system, create vendor-specific interfacing for user browsing, allow said vendors to upload coupons for user selection, allow vendors to visualize said user statistics and to allow vendors to create mailing distribution lists;
a user-specific card retained by said user that comprises a readable interface for cross-referencing said user information with said computer system database information and for accessing said user-chosen coupons for redemption;
a vendor checkout station having a means to read said user-specific card information during a checkout process, whereby said card reading means decodes said user card information, contacts said computer system database, finds said vendor coupons retained by said user, and applies said coupon to a sale in-progress during said checkout.

2) The system of claim 1, wherein said online interface is accessed via a local personal computer by the user or vendor.

3) The system of claim 1, wherein said online interface is accessed via a mobile phone application by the user.

4) The system of claim 1, wherein said interface further allows users to follow specific vendors for exclusive coupon distribution and notification of coupon distribution.

5) The system of claim 1, wherein said interface is available for use by registered users and registered vendors, and further by guest users who are provided limited access to coupons and browsing rights through said database.

6) The system of claim 5, wherein said guest users are only able to download and print physical coupons, while registered users are provided said card for redeeming coupons.

7) The system of claim 1, wherein said users are able to swap coupons between different users within said web interface for transferring exclusive or otherwise unavailable vendor coupons.

8) The system of claim 1, wherein said users are able to message said vendors for specific comments or questions through said system.

9) A method of distributing coupons, comprising the steps of:
providing a computer system having a database listing of registered users, vendors, coupons from said vendors, mailing distribution lists and user information, spending and browsing statistics;
providing an online interactive to said computer system for said users and said vendors to access, interact with and browse through;
allowing said users to register on said system, browse vendors and vendor coupons, interact with other users and join mailing distribution lists;
allowing vendors to register on said system, create vendor-specific interfacing for user browsing, allow said vendors to upload coupons for user selection, allow vendors to visualize said user statistics and to allow vendors to create mailing distribution lists;
providing user-specific cards retained by said user that comprise a readable interface
cross-referencing said user information with said computer system database information and for accessing said user-chosen coupons for redemption;
utilizing said card reading vendor checkout station having a means to read said user-specific card information during a checkout process, decode said user card information, contact said computer system database, find said vendor coupons retained by said user, and apply said coupon to a sale in-progress during said checkout.

10) The method of claim 9, wherein said online interface is accessed via a local personal computer by the user or vendor.

11) The method of claim 9, wherein said online interface is accessed via a mobile phone application by the user.

12) The method of claim 9, further comprising the steps of allowing users to follow specific vendors for exclusive coupon distribution and notification of coupon distribution.

13) The method of claim 9, further comprising the steps of allowing access to said interface for use by registered users and registered vendors, and further limited access by unregistered guest users who are provided limited access to coupons and browsing rights through said database.

14) The method of claim 13, further comprising the steps of only allowing guest users to download and print physical coupons, while registered users are provided said card for redeeming coupons.

15) The method of claim 9, further comprising the steps of allowing users to swap coupons between different users within said web interface for transferring exclusive or otherwise unavailable vendor coupons.
